(19) United States
(12) Patent Application Publication
(10) Pub. No.: US 2003/0164256 A1
(43) Pub. Date: Sep. 4, 2003

(54) Aircraft support vehicle

(76) Inventors: Angus John Fraser Murray, Lancashire (GB); Neil William Simpson, Lancashire (GB); Ian Matthew Watson, Lancashire (GB)

Correspondence Address: NIXON & VANDERHYE, PC, 1100 N GLEBE ROAD, 8TH FLOOR, ARLINGTON, VA, 22201-4714, US

(21) Appl. No.: 10/362,418

(22) PCT Filed: Aug. 24, 2001
(86) PCT No.: PCT/GB01/03794

(30) Foreign Application Priority Data
Aug. 25, 2000 (GB) 0020970.0

(51) Int. Cl. B60K 8/00

(52) U.S. Cl. 180/54.1

(57) ABSTRACT

A multi-purpose ground support vehicle for an aircraft comprises a four wheel drive land vehicle in which the main power unit is also connected to an aircraft services gearbox by a power take-off shaft to provide a self-propelled aerospace ground equipment facility in a variety of terrains. The aircraft services gearbox includes a plurality of service devices such as e.g. a hydraulic pump, an electrical generator, a low or high pressure air compressor etc.

This invention relates to aircraft support vehicles for providing support services for aircraft and in particular, but not exclusively, to self-propelled multipurpose support vehicles capable of operating in a wide range of terrains.

The operators of military aircraft have to support operations in many locations often far from their main operating base and with few facilities at the remote location. This means that they must transport all the required equipment, incurring large logistics penalties and cost At present aircraft support functions such as ground electrical power, hydraulic power, low pressure air and high pressure gas supplies etc., are provided by separate items of aerospace ground equipment usually mounted on towed trailers requiring a tractor unit to move them between operating areas. Any method of reducing the quantity of equipment will be an advantage to the operator.

U.S. Pat. No. 3,886,701 describes a ground support unit for servicing aircraft including a tractor unit with a generator on the back of the unit and driven off the tractor powerplant. This device simply provides electrical power. It cannot supply any of the other services required by military aircraft.

The present invention is therefore concerned with reducing the logistics burden or logistics “footprint” by combining functions previously provided in separate towed items of aerospace ground equipment.

Accordingly, in one aspect, this invention provides a self-propelled ground support vehicle for an aircraft, said vehicle comprising:—

a wheeled main body portion;

a cab portion containing driver controls for the vehicle;

a main power unit;

a ground wheel drive train connected to the power unit for transmitting drive from the power unit to at least two of the vehicle wheels;

an aircraft services gearbox connected to the power unit and supplying drive to at least two aircraft service devices.

Preferably the aircraft service devices include one or more of the following service devices:—

a hydraulic pump;

an electrical generator;

a low pressure air compressor;

a high pressure air compressor, and

a cooling device.

By this arrangement the need for separate towed aerospace ground equipment is obviated and a multifunctional vehicle may be provided which is capable of operation over a wide range of terrain.

The construction of the support vehicle may be modular to enable it readily to be configured during manufacture for one of several different uses.

Preferably the vehicle includes respective independent clutch means between the power unit and the ground wheel drive train, and between the power unit and said aircraft services gearbox respectively.

The control means for selecting and controlling the services driven by the aircraft services gearbox is preferably provided within the cab portion although auxiliary controls may be provided elsewhere in the vehicle at an externally accessible location.

The power unit preferably comprises a dual fuel internal combustion engine capable of running on aviation fuel (AVTUR) or diesel fuel.

Preferably, the ground wheel drive train transmits drive to four or more vehicle wheels.

Preferably said main body portion includes externally accessible inlet/outlet connections for at least some of the services driven by said aircraft services gearbox. For convenience and speed of operation, the main body portion may include externally accessible duplicate inlet/outlet connections to opposite sides of the main body portion for at least some of said services.

Preferably said main body portion includes a load space for carrying support equipment. The support equipment may comprise one or more of:—

a towing arm;

gas storage vessels;

test equipment;

crash recovery equipment;

a fork lift device;

a hoist, and

tools.

Preferably said main body portion includes shutter means for closing said load space.

Preferably the load space is covered by a covered roof which is strengthened to serve as a work platform. One or more movable floodlights may be provided on the roof or elsewhere on the vehicle.

The vehicle also preferably includes a towing point on the front and/or rear of the vehicle. Likewise the vehicle preferably includes a winch means on the front and/or rear of the vehicle.

Whilst the invention has been described above it extends to any inventive combination set out above or in the following description.

The invention may be performed in various ways, and an embodiment thereof will now be described, by way of example only, reference being made to the accompanying drawings in which:—

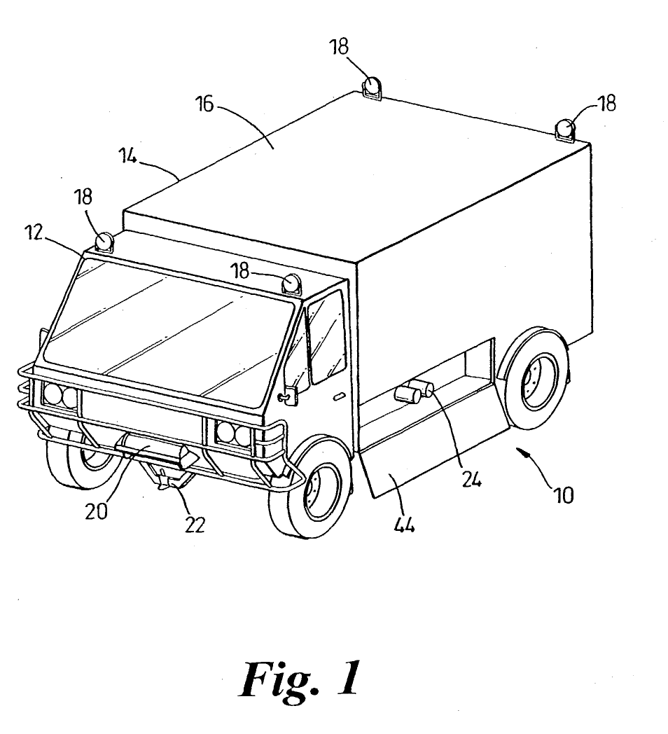

FIG. 1 is a front perspective view of a multipurpose ground support vehicle in accordance with this invention;

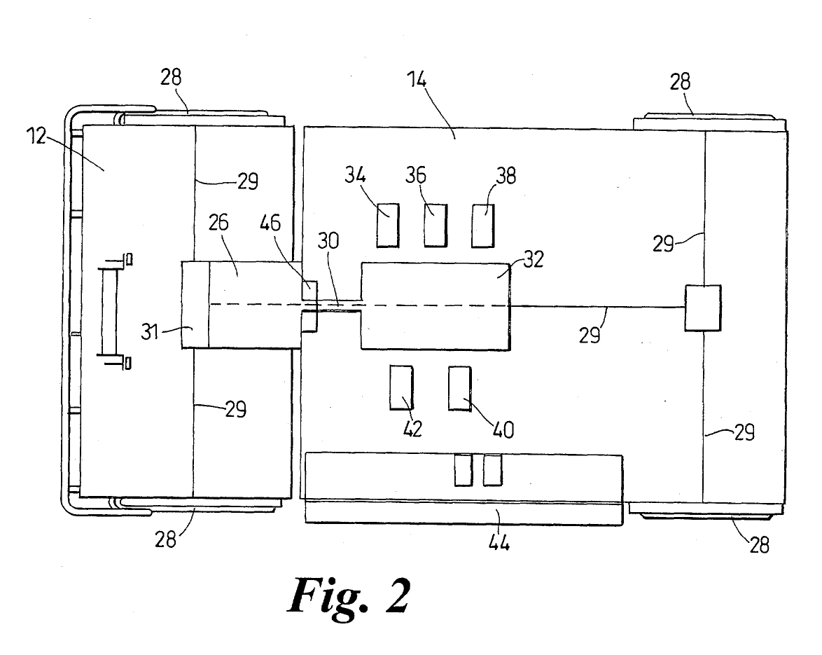

FIG. 2 is a section view looking down through the floor area of the multi-purpose support vehicle of FIG. 1;

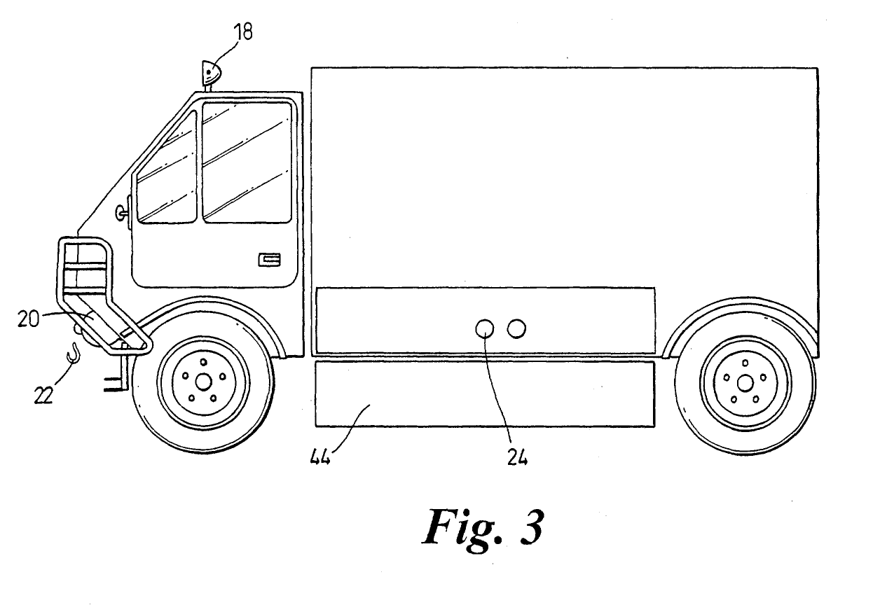

FIG. 3 is a side view of the multi-purpose support vehicle of FIG. 1, and

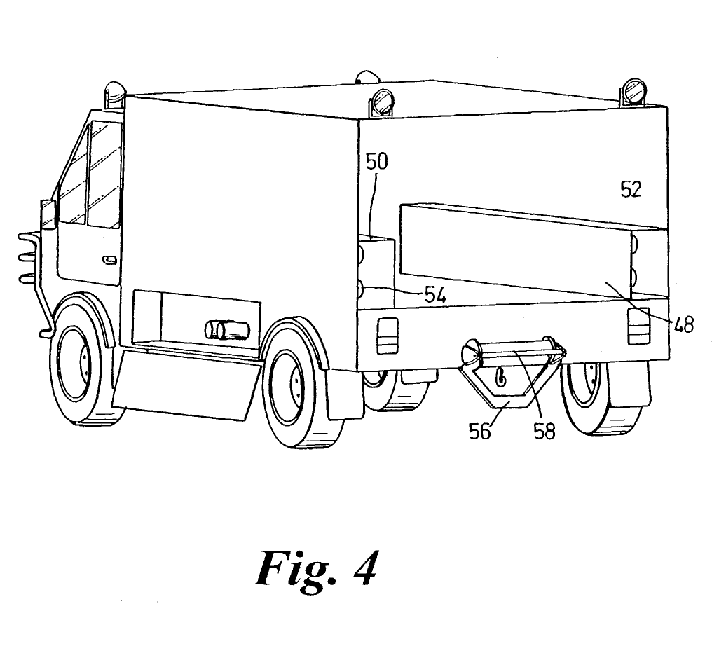

FIG. 4 is a perspective view from the rear showing the equipment load space of the multi-purpose support vehicle of FIG. 1.

The multi-purpose support vehicle illustrated in the Figures combines several aerospace ground equipment functions into a single, self-propelled vehicle with rough terrain capability and the ability to be tailored in terms of the on-board features through a modular build concept. The vehicle illustrated is intended to be built on the basis of an existing four wheel drive all-terrain vehicle.

Referring initially to FIG. 1, the vehicle 10 comprises a cab portion 12, a load space 14 and, in this embodiment, four wheels. The load space 14 has a strengthened roof 16 which may be used as a work platform. Movable floodlights 18 are disposed at the upper four corners of the vehicle. At the front of the vehicle there is provided a winch 20 and a towing hitch 22. To the left and right hand sides of the vehicle is a connector bay 24.

Whilst not shown, the strengthened roof 16 may be provided with retractable safety rails (not shown), with the roof being accessible via an access ladder.

Referring now to FIG. 2, the vehicle engine 26 is connected to the four road wheels 28 by a generally conventional four wheel drive power train indicated schematically by lines 29, via a clutch 31. The engine 26 is capable of running on either diesel or AVTUR. A power offtake shaft 30 from the engine supplies power to an aircraft services gearbox or aircraft accessory drive 32. This may be based on an existing aircraft gearbox and modified to suit requirements. In the illustrated embodiment, the aircraft services gearbox has a single input drive. However if a specialised input drive is required (e.g. airflow or pressure) it may be necessary to drive the aircraft services gearbox from a separate power source e.g. a small gas turbine. The aircraft services gearbox 32 in this embodiment supplies power to a system cooling device 34, a low pressure air compressor 36, a high pressure air compressor 38, an electrical generator 40, and a hydraulic pump 42. The system cooling device 34 provides additional cooling for the aircraft avionic systems if the onboard aircraft cooling system is not capable of maintaining the avionics system within the required temperature range—for example if the external air temperature is very high. The system cooling device may therefore comprise the components found on a conventional towed ground cooling trolley. The number of output drives and aircraft services so provided will vary in number and configuration depending on the aircraft type for which the multi-purpose support vehicle is being configured. In many instances, the aircraft services gearbox will be the same item, or modified from the same item, as is fitted to the aircraft for which the multipurpose support vehicle is being configured.

The services (34 to 42) are supplied to respective connectors (only two of which are shown) in the connector bays 24 to either side of the vehicle (only one of which is shown in FIG. 2). The connector bays are each accessible via a closeable door 44. A clutch 46 allows the power to the aircraft services gearbox to be disengaged.

Referring now to FIG. 4, the load space 14 may house test equipment, crash recovery equipment, tools or other items such as a forklift and a hoist, as required. The load space may be closed by means of a roller shutter or the like (not shown). The load space may also include lockers 48 and 50 for storing a towing arm (in dismantled form) and one or more gas bottles 54. At the rear of the vehicle is provided a further towing hitch 56 and a further winch 58.

It is emphasised that the number and nature of the aircraft services may vary from those described above, which are examples only. The modular nature of the system allows other services to be accommodated, depending on specific aircraft requirements. Likewise the contents of the load department will be selected according to specific aircraft requirements.

1. A self propelled ground support vehicle for an aircraft, said vehicle comprising:—
a wheeled main body portion;
a cab portion containing driver controls for the vehicle;
a main power unit;
a ground wheel drive train connected to the power unit for transmitting drive from the power unit to at least two of the vehicle wheels;
an aircraft services gearbox connected to the power unit and supplying drive to at least two aircraft service devices.

2. A self propelled ground support vehicle according to claim 1, wherein said at least two aircraft service devices includes one or more of the following devices:
a hydraulic pump;
an electrical generator;
a low pressure air compressor;
a high pressure air compressor, and
a cooling device.

3. A self-propelled ground support vehicle according to claim 1 or 2, wherein respective independently operable clutch means are provided between said power unit and the ground wheel drive train and said aircraft services gearbox respectively.

4. A self-propelled ground support vehicle according to any preceding claim, wherein control means for selecting and controlling the services driven by said aircraft services gearbox is provided in said cab portion.

5. A self-propelled vehicle according to any of the preceding claims, wherein said main power unit comprises a dual fuel internal combustion engine capable of running on aviation fuel (AVTUR) or diesel fuel.

6. A self-propelled vehicle according to any of the preceding claims, wherein said ground wheel drive train transmits drive to four or more vehicle wheels.

7. A self-propelled vehicle according to any of the preceding claims, wherein said main body portion includes externally accessible service inlet/outlet connections for at least some of the services driven by said aircraft services gearbox.

8. A self-propelled vehicle according to claim 7, wherein said main body portion includes externally accessible duplicate inlet/outlet connections to opposite sides of the main body portion for at least some of said services.

9. A self-propelled vehicle according to any of the preceding claims, wherein said main body portion includes an externally accessible load space for carrying support equipment.

10. A self-propelled vehicle according to claim 9, wherein said support equipment comprises one or more of:
a towing arm
gas storage vessels
test equipment
crash recovery equipment
a forklift device
a hoist
tools.

11. A self-propelled vehicle according to claim 9 or claim 10, wherein said main body portion includes shutter means for closing said load space.

12. A self-propelled vehicle according to any of claims 9 to 11, wherein said load space is covered by a strengthened roof.

13. A self-propelled vehicle according to any of the preceding claims including one or more moveable floodlights.

14. A self-propelled vehicle according to any of the preceding claims, which includes a towing point on the front and/or rear of the vehicle.

15. A self-propelled vehicle according to any of the preceding claims, which includes a winch means on the front and/or rear of the vehicle.

16. A self-propelled vehicle substantially as hereinbefore described with reference to and as illustrated in any of the accompanying drawings.
